(19) United States
(12) Patent Application Publication
(10) Pub. No.: US 2026/0239404 A1
(43) Pub. Date: Aug. 13, 2026

(54) SOUNDING REFERENCE SIGNAL RESOURCE INTERFERENCE RANDOMIZATION

(71) Applicant: Apple Inc., Cupertino, CA (US)

(72) Inventors: Haitong Sun, Cupertino, CA (US); Wei Zeng, Saratoga, CA (US); Jie Cui, San Jose, CA (US); Dawei Zhang, Saratoga, CA (US); Chunxuan Ye, San Diego, CA (US)

(21) Appl. No.: 19/156,027

(22) PCT Filed: Jan. 18, 2024
(86) PCT No.: PCT/US2024/012020

§ 371 Date: Aug. 13, 2025

Related U.S. Application Data
(60) Provisional application No. 63/445,640, filed on Feb. 14, 2023.

(51) Int. Cl. H04W 72/541; H04L 5/00; H04W 72/231

(52) U.S. Cl. CPC H04W 72/541; H04L 5/0042; H04L 5/0051; H04L 5/0094; H04W 72/231

(57) ABSTRACT

A user equipment (UE) includes a set of transceivers and a processor. The processor may be configured to receive a sounding reference signal (SRS) configuration that includes an SRS hopping indicator. The processor may also be configured to generate a first pseudo-random sequence. The first pseudo-random sequence may be based at least in part on the SRS hopping indicator. Additionally, the processor may be configured to transmit, via the one or more transceivers, a first SRS transmission in a first symbol. In some examples, the first SRS transmission is transmitted in accordance with at least one of a first transmission comb offset, or a first cyclic shift, that is based at least in part on the generated first pseudo-random sequence.

### CROSS-REFERENCE TO RELATED APPLICATION

This Patent Cooperation Treaty patent application claims priority to U.S. Provisional Patent Application No. 63/445,640, filed Feb. 14, 2023, and titled “Sounding Reference Signal Resource Interference Randomization” the contents of which are incorporated herein by reference in its entirety.

### TECHNICAL FIELD

This application relates generally to wireless communication systems, including techniques for configuring sounding reference signals (SRS) resource interference randomization in wireless communication systems.

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device or base station is an Evolved Universal Terrestrial Radio Access Network (E-UTRAN) Node B (also commonly denoted as evolved Node B, enhanced Node B, eNodeB, or eNB). One example of an NG-RAN network device or base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example wireless communication system including an example of UEs and a network device in a 5G or NR network.

FIG. 2 illustrates a first example method of wireless communication by a UE.

FIG. 3 illustrates a second example method of wireless communication by a UE.

FIG. 4 illustrates a third example method of wireless communication by a UE.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In a scalable multiple-input and multiple-output (MIMO) wireless communication system, a 3GPP network such as, for example, 5G or NR (hereafter referred to as “network”), may transmit different uplink (UL) or downlink (DL) signals, at different times, using different numbers of antenna ports. The number of antenna ports used to transmit a particular UL or DL signal may be based on factors and considerations such as, but not limited to, dynamic point(s) selection (e.g., transmission and reception point (TRP) selection), interference management, and network power saving considerations.

In some cases, beamforming and MIMO operations on UL involve SRS transmission and measurement. That is, a UE may be configured, for example with respect to 3GPP NR Release 15, to transmit the SRS from 1, 2 or 4 antenna ports. These antenna ports (sometimes referred to as SRS ports) may be designated or numbered as 1000, 1001, 1002 and 1003. An SRS may, for example, occupy 1, 2 or 4 symbols in the time domain, which may be located within the last 6 symbols of a slot. An SRS may, for example, occupy up to 272 resource blocks in the frequency domain, and while a particular UE may not transmit the SRS on every subcarrier, the UE may utilize a transmission comb for selecting a specific set of subcarriers. For example, transmission comb sizes of 2 and 4 may be supported to allow groups of UE to be frequency multiplexed. That is, a transmission comb size 2 means that the particular UE transmits on every second subcarrier and a transmission comb size 4 means that the particular UE transmits on every fourth subcarrier.

In other NR releases, for example with respect to 3GPP NR Release 16, an SRS may also occupy 8 or 12 symbols in the time domain, which may be located within any symbol of a slot. Additionally, NR Release 16 may support a transmission comb size of 8 as well as a number of cyclic shifts for each transmission comb size. That is, for every cyclic shift, an orthogonal cover code (OCC) can be created using discrete Fourier transform (DFT) techniques to aid in mitigating interference for SRS transmission using the same transmission comb offset.

However, SRS enhancements are desirable to support further NR releases and next generation wireless communication systems. For example, aspects disclosed herein relate to SRS resource interference randomization techniques using a long pseudo-random sequence design. In some embodiments, the techniques include the configuration of SRS hopping identifiers for initializing pseudo-random sequences that may be used for randomized hopping of SRS transmissions.

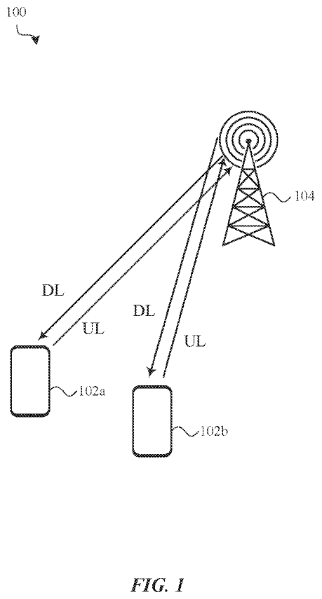

FIG. 1 illustrates an example wireless communication system 100, in accordance with some embodiments and various aspects of the present disclosure. Wireless communication system 100 may be a 5G or NR network as an example environment in which embodiments described herein may be practiced. In some embodiments, wireless communication system 100 may include one or more UEs (e.g., a first UE 102a and a second UE 102b) and a network device 104 (e.g., a network device of a RAN, such as but not limited to a base station). The first UE 102a may communicate with the one or more cells of the network device 104 on a DL and an UL. Additionally, the second UE 102b may communicate with the one or more cells of the network device 104 on a DL and an UL.

Each of the first UE 102a and the second UE 102b may transmit SRS to the one or more cells of the network device 104 and/or the one or more cells of another network device proximate to the network device 104. The network device 104 may measure the UL propagation channel from the SRS transmissions. In some cases, an SRS may be transmitted by the first UE 102a in accordance with configurations and instructions from the network device 104 or another network device in the wireless communication system 100. However, another UE, for example, the second UE 102b may transmit an SRS with the same characteristics (e.g., a same transmission comb offset and/or a same cyclic shift. Accordingly, the SRS transmission of the second UE 102b may interfere with the SRS transmission of the first UE 102a. Additionally, it is to be understood that the interference may occur on each symbol in the SRS transmissions of both the first UE 102a and the second UE 102b. That is, conventional SRS transmissions may use a same transmission comb and cyclic shift for each symbol.

In some embodiments described herein, techniques for hopping randomization between different transmission comb offsets and/or hopping randomization between different cyclic shifts are described to mitigate such interference in SRS transmissions. That is, for example, the first UE 102a may transmit an SRS with a different transmission comb offset at a subsequent time instance (e.g., at a next symbol in an SRS resource) than a transmission comb offset used for an initial transmission (e.g., at a first symbol in an SRS resource) of the SRS. Additionally or alternatively, the first UE 102a may transmit an SRS with a different cyclic shift at a subsequent time instance (e.g., at a next symbol in an SRS resource) than a cyclic shift used for an initial transmission (e.g., at a first symbol in an SRS resource) of the SRS. The subsequent time instance may be a next time location for a next SRS transmission in a next symbol of a same slot (e.g., intra-slot SRS hopping randomization), a next SRS transmission in a next slot, a next SRS transmission in a next subframe, or a next SRS transmission in a next frame in accordance with some embodiments. That is, for example, the transmission comb hopping randomization and/or the cyclic shift hopping randomization may occur in the time domain to more effectively avoid or mitigate interference with another UE (e.g., the second UE 102b) that may be configured with a same static transmission comb and/or a same static cyclic shift in a neighboring cell.

In some embodiments, the SRS transmission comb hopping randomization and/or the cyclic shift hopping randomization enhancements correspond to both Frequency Range 1 (FR1) and Frequency Range 2 (FR2). That is, for example, these SRS enhancements may be implemented by a UE and/or network device operating in both FR1 (e.g., in a frequency range of 410 MHz-7125 MHz) and FR2 (e.g., in a frequency range of 24250 MHz-52600 MHz). In some embodiments, the SRS transmission comb hopping randomization and/or the cyclic shift hopping randomization enhancements described herein may be implemented, at least partially, under an existing SRS and/or pseudo-random sequence framework. That is, for example, the SRS enhancements described herein may use information elements and/or parameter structures specified in an existing 3GPP NR release (e.g., NR Release 15, 16 or 17). Moreover, the SRS enhancements described herein, either in addition to or specified in an existing SRS and/or pseudo-random sequence framework, may be configured via radio resource control (RRC) signaling (e.g., higher layer signaling) and may potentially be triggered or activated through MAC control element (MAC CE) and/or downlink control information (DCI).

As used herein, an SRS may refer to SRS configured for channel quality measurements or SRS configured for positioning purposes. A collection of resource elements that are used for transmission of SRS may be referred to as an SRS resource, and may be identified by the parameter ‘SRS-ResourceId.’ In some embodiments, the collection of resource elements may span multiple physical resource blocks (PRBs) in the frequency domain and N (e.g., one or more) consecutive symbol(s) within a slot in the time domain. That is, for example, in a given OFDM symbol, an SRS resource may occupy consecutive PRBs. In some embodiments, an SRS resource set is a set of SRS resources used for the transmission of SRS (e.g., SRS signals) and may be identified by the parameter ‘SRS-ResourceSetId’. It is to be appreciated that other constructs of the SRS-related information elements and/or parameters may be used additionally or alternatively given the benefit of the present disclosure.

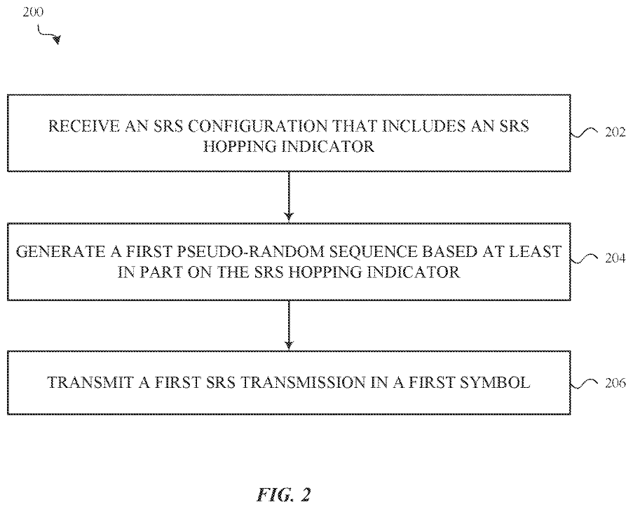

FIG. 2 illustrates a first example method 200 of wireless communication by a UE, in accordance with some embodiments and various aspects of the present disclosure. The method 200 may be performed by the first UE 102a or the second UE 102b described with reference to FIG. 1 or by other UEs described herein. The method 200 may be performed using a processor, a set of transceivers (e.g., one or more transceivers) or other components of a UE.

At 202, the method 200 may include receiving an SRS configuration that includes an SRS hopping indicator.

At 204, the method 200 may include generating a first pseudo-random sequence based at least in part on the SRS hopping indicator.

At 206, the method 200 may include transmitting a first SRS transmission in a first symbol.

In some embodiments of the method 200, the first SRS transmission may be transmitted in accordance with at least one of a first transmission comb offset, or a first cyclic shift, that is determined based at least in part on the generated first pseudo-random sequence.

In some embodiments of the method 200, the SRS hopping indicator may be an indication the UE is to implement SRS transmission comb offset hopping randomization and/or cyclic shift hopping randomization. That is, for example, the initialization seed (e.g., cᵢₙᵢₜ) to be used may be known a priori by the UE and the network device. In some embodiments, the SRS hopping indicator may include or indicate an initialization seed (e.g., cᵢₙᵢₜ) for the first pseudo-random sequence. In some embodiments, the SRS hopping indicator may include or indicate at least some value or information that may be used for the initialization seed for the first pseudo-random sequence. In some embodiments, the SRS hopping indicator may be an SRS hopping identifier (e.g., including an explicit value that may be used for the initialization seed).

In some embodiments of the method 200, for example, the first pseudo-random sequence includes a length-31 Gold sequence.

That is, for example, the length-31 Gold sequence used by the UE for other pseudo-random sequence generation purposes may be used for determining the SRS transmission comb offset hopping randomization and/or cyclic shift hopping randomization. In some embodiments, however, different types of pseudo-random sequences may be used for determining the SRS transmission comb offset hopping randomization and/or cyclic shift hopping randomization.

In some embodiments of the method 200, for example, the UE may be configured to transmit a second SRS transmission in a second symbol. That is, for example, the first SRS transmission may be transmitted in accordance with at least one of the first transmission comb offset, or the first cyclic shift, that is determined based at least in part on a first portion of the generated first pseudo-random sequence. The second SRS transmission may be transmitted in accordance with at least one of a second transmission comb offset, or a second cyclic shift, that is determined based at least in part on a second portion of the generated first pseudo-random sequence. In some embodiments, the first portion of the generated first pseudo-random sequence is different from the second portion of the generated first pseudo-random sequence.

That is, for example, a single pseudo-random sequence may be generated for all symbols that are to include SRS transmission. Additionally or alternatively, each symbol may use a different portion of the same pseudo-random sequence. That is, for example, the first transmission comb offset, and/or the first cyclic shift, may be determined based at least in part on a first number of sequential bits and position (e.g., the first through third bits) in the generated first pseudo-random sequence. The second transmission comb offset, and/or the second cyclic shift, may be determined based at least in part on a second number of sequential bits and position (e.g., the fourth through sixth bits) in the generated first pseudo-random sequence. Additional symbols (e.g., a third symbol, a fourth symbol, a fifth symbol, etc.) that are to include SRS transmissions may also be configured for SRS hopping randomization for transmission comb offsets and/or the cyclic shifts determined in a similar manner.

In some embodiments of the method 200, for example, the UE may be configured to generate a second pseudo-random sequence based at least in part on the SRS hopping indicator. The UE may also be configured to transmit a second SRS transmission in a second symbol. In some embodiments, the second SRS transmission may be transmitted in accordance with at least one of a second transmission comb offset, or a second cyclic shift, that is determined based at least in part on the generated second pseudo-random sequence.

That is, for example, different pseudo-random sequences may be generated for different symbols that are to include SRS transmissions. In some embodiments, each symbol may use a fixed portion of the corresponding pseudo-random sequence. That is, for example, the first transmission comb offset, and/or the first cyclic shift, may be determined based at least in part on a number of sequential bits and position (e.g., the first through third bits) in the generated first pseudo-random sequence. The second transmission comb offset, and/or the second cyclic shift, may be determined based at least in part on the same number of sequential bits and position (e.g., the first through third bits) in the generated second pseudo-random sequence as the number of sequential bits and position used for the first pseudo-random sequence. Additional symbols (e.g., a third symbol, a fourth symbol, a fifth symbol, etc.) that are to include SRS transmission may also be configured for SRS hopping randomization for transmission comb offsets and/or the cyclic shifts determined in a similar manner.

In some embodiments of the method 200, for example, the SRS hopping indicator may include an initialization seed for the first pseudo-random sequence.

That is, for SRS transmission comb offset hopping randomization and/or cyclic shift hopping randomization, the network or the network device may configure the SRS hopping indicator to include an identifier, or, in some cases, be an SRS hopping identifier. In some embodiments, the identifier

$$( e . g . , {n}_{ID}^{SRS , Hopping} )$$

may be used to initialize the first pseudo-random sequence. That is, for example, the first pseudo-random sequence may be initialized with an initialization seed

$$( e . g . , {c}_{init} = {n}_{ID}^{SRS , Hopping} )$$

based at least in part on the SRS hopping indicator. It is to be appreciated that, in accordance with some embodiments, the initialization seed may generate a long pseudo-random sequence as the first pseudo-random sequence that repeats itself every 2³¹−1 entries. Each entry in the generated first pseudo-random sequence may be either 0 or 1.

In some embodiments, the network device may send the SRS hopping indicator to the UE via RRC signaling. In some embodiments, the network device may send the SRS hopping indicator to the UE via a MAC CE. In some embodiments, the network device may send the SRS hopping indicator to the UE via a DCI message.

In some embodiments of the method 200, for example, at least one of the first transmission comb offset, or the first cyclic shift, may be determined based at least in part on a first number of consecutive entries in the generated first pseudo-random sequence. In some embodiments, the first number of consecutive entries may correspond to one or both of a transmission comb size (e.g., 2, 4 or 8) or a maximum number of cyclic shifts (e.g., 8, 12 or 6) associated with the first SRS transmission. The transmission comb size and the maximum number of cyclic shifts, for example, may be determined based at least in part on the SRS configuration.

That is, for SRS transmission comb offset hopping randomization and/or cyclic shift hopping randomization, the network or the network device may configure the SRS hopping indicator to include an identifier

$$( e . g . , {n}_{ID}^{SRS , Hopping} )$$

to initialize the first pseudo-random sequence. The first pseudo-random sequence may be initialized with an initialization seed

$$( e . g . , {c}_{i n i t} = {n}_{ID}^{SRS , Hopping} )$$

based at least in part on the SRS hopping indicator. In some embodiments, each symbol that is to include SRS transmission in a particular slot of a particular radio frame, may be allocated consecutive entries (e.g., bits) from a generated pseudo-random sequence sequentially to form an SRS hopping pattern for that particular symbol. The number of consecutive entries allocated may correspond to the number of transmission comb offsets and/or the number of cyclic shifts possible for the SRS transmission.

In some embodiments, an output sequence c(n), n=0, 1, 2, 3, . . . to the n^{th} entry in a long pseudo-random sequence may be employed for the SRS transmission comb offset hopping randomization and/or the cyclic shift hopping randomization. For symbol l, where

$$l = 0 , 1 , 2 , 3 , … , {N}_{symb}^{slot} - 1 in slot {n}_{s , f}^{μ} . , where {n}_{s , f}^{μ}$$

is the slot index within a frame and

$${n}_{s , f}^{μ} = 0 , 1 , 2 , 3 , … ,$$

the symbol index may be denoted as

$${n}_{symb} = {N}_{symb}^{slot} {n}_{s , f}^{μ} + l , where {N}_{symb}^{slot}$$

is the number of symbols per slot.

In some embodiments, the entries used for SRS hopping randomization may be c(n_{symb} M), c(n_{symb} M+1), . . . , c(n_{symb} (M+1)−1).

A transmission comb size or number (e.g., K_{TC}) may be 2, 4 or 8 in accordance with some embodiments. For a transmission comb size of 2, a maximum number of cyclic shifts

$$( e . g . , {n}_{SRS}^{cs , max} )$$

may be 8. For a transmission comb size of 4, a maximum number of cyclic shifts may be 12. And for a transmission comb size of 8, a maximum number of cyclic shifts may be 6. If the transmission comb size is 2, the number of consecutive entries (e.g., bits) allocated may be 1 (e.g., for selecting among two possible transmission comb offsets from 0 or 1). If the transmission comb size is 4, the number of consecutive entries allocated may be 2 (e.g., for selecting among four possible transmission comb offsets from 00, 01, 10, or 00). If the transmission comb size is 8, the number of consecutive entries allocated may be 3 (e.g., for selecting among eight possible transmission comb offsets from 000, 001, 010, 011, 100, 101, 110, or 111).

Similarly, if the maximum number of cyclic shifts is 8, the number of consecutive entries (e.g., bits) allocated may be 3 (e.g., for selecting among eight possible cyclic shifts from 000, 001, 010, 011, 100, 101, 110, or 111). If the maximum number of cyclic shifts is 12, the number of consecutive entries allocated may be 4 (e.g., for selecting among twelve possible cyclic shifts from 0000, 0001, 0010, 0011, 0100, 0101, 0110, 0111, 1000, 1001, 1010, or 1011, where 1100, 1101, 1110, and 1111 are not used or indicate a value in the range of 1 through 12). If the maximum number of cyclic shifts is 6, the number of consecutive entries allocated may be 2 (e.g., for selecting among six possible cyclic shifts from 000, 001, 010, 011, 100, and 101, where 110 and 111 are not used or indicate a value in the range of 1 through 6).

In a non-limiting example, the first entries (e.g., bits) of the generated pseudo-random sequence (e.g., c(n)) may be 10101100110011. For example, the transmission comb size (e.g., K_{TC}) may be 8 such that the number of consecutive entries (e.g., bits) allocated to indicate a particular transmission comb offset may be 3 (e.g., M=3). If four symbols are to include SRS transmissions in the slot, for example, a first portion of the generated pseudo-random sequence including the first three consecutive entries {010} may be used to determine the transmission comb offset for a first symbol in the slot. A second portion of the generated pseudo-random sequence including the next three consecutive entries {110} may be used to determine the transmission comb offset for a second symbol in the slot. A third portion of the generated pseudo-random sequence including the next three consecutive entries {011} may be used to determine the transmission comb offset for a third symbol in the slot. A fourth portion of the generated pseudo-random sequence including the next three consecutive entries {001} may be used to determine the transmission comb offset for a fourth symbol in the slot.

That is, for example, the transmission comb offset may be hopping in a randomized manner with respect to the corresponding SRS transmissions in each of the four symbols in the slot (e.g., intra-slot SRS transmission comb offset hopping). It is to be appreciated that the above non-limiting example may be similarly applied to other transmission comb sizes (e.g., 2 or 4) as well as cyclic shifts (e.g., 8, 12 or 6) in accordance with the various embodiments described herein.

In some embodiments, the SRS configuration may include a higher layer parameter (e.g., transmissionComb) in an information element (e.g., SRS-Resource), which may indicate the transmission comb size (e.g., K_{TC}) and the maximum number of cyclic shifts

$$( e . g . , {n}_{SRS}^{cs , max} )$$

to be used by the UE. Additionally, in some embodiments, the network device may send the SRS configuration that includes the SRS hopping indicator and other SRS information such as but not limited to the information element (e.g., SRS-Resource) to the UE via RRC signaling. However, in some embodiments, the network device may send the SRS configuration that includes the SRS hopping indicator and other SRS information to the UE via a MAC CE and/or a DCI message.

In some embodiments of the method 200, for example, the UE may be configured to use an initialization seed for the first pseudo-random sequence, based at least in part on at least one of a size of SRS hopping indicator or a symbol index for the first symbol. The initialization seed may be obtained from a predefined set of seeds or determined by the UE.

That is, for SRS transmission comb offset hopping randomization and/or cyclic shift hopping randomization, the network or the network device may configure the SRS hopping indicator to include an identifier

$$( e . g . , {n}_{ID}^{SRS , Hopping} ) .$$

The SRS hopping indicator and identifier thereof may have a size (e.g., a length of a bit field or a numerical value) that can vary in accordance with some embodiments. In some embodiments, the network or the network device may identify a symbol index (e.g., 1) for the first symbol and other symbols that are to include SRS transmission. In some embodiments, the initialization seed for the first pseudo-random sequence may be determined, based at least in part on any one, or both of the size of the SRS hopping indicator or the symbol index for the first symbol.

In a non-limiting example, cᵢₙᵢₜ may be determined according to the following equation:

$${c}_{init} = ( {2}^{K} ( {N}_{symb}^{slot} {n}_{s , f}^{μ} + l + 1 ) ( 2 {n}_{ID}^{SRS , Hopping} + 1 ) + {n}_{ID}^{SRS , Hopping} ) mod {2}^{31} \qquad ( eq . 1 )$$

In another non-limiting example, cᵢₙᵢₜ may be determined according to the following equation:

$${c}_{init} = ( {2}^{K} ( {N}_{symb}^{slot} {n}_{s , f}^{μ} + l + 1 ) ( 2 {n}_{ID}^{SRS , Hopping} + 1 ) + 2 {n}_{ID}^{SRS , Hopping} ) mod {2}^{31} \qquad ( eq . 2 )$$

In Equations 1 and 2, l is the symbol index

$$( e . g . , l = 0 , 1 , 2 , 3 , … , {N}_{symb}^{slot} - 1 ) ; {n}_{s , f}^{μ}$$

is the slot index within a frame

$$( e . g . , {n}_{s , f}^{μ} = 0 , 1 , 2 , 3 , … , etc . ) ; {N}_{symb}^{slot} .$$

is the number of symbols per slot; K is a fixed integer value depending on the size of

$${n}_{ID}^{SRS , Hopping} .$$

However, it is to be appreciated that other initialization seeds may be employed using various techniques as would be understood given the benefit of Equations 1 and 2 along with the various embodiments described herein.

That is, for example, a new pseudo-random sequence may be initialized using a different and time-varying initialization seed for each symbol that is to include an SRS transmission. In this manner, only a first fixed portion of the generated pseudo-random sequence need be referenced to determine the transmission comb offset and/or cyclic shift for the randomized hopping to be implemented in each symbol that is to include an SRS transmission. It is to be understood, however, that any portion of the generated pseudo-random sequence may be used for the M number of consecutive entries (e.g., bits). For example, a middle portion of consecutive entries or a last portion of consecutive entries when a relatively small pseudo-random sequence is generated may be used for the M number of consecutive entries in accordance with some embodiments. Additionally, in some embodiments, the portion of the generated pseudo-random sequence need not be consecutive (e.g., bits 2, 4 and 6 for M=3), but it may be preferable that the portion be fixed with respect to a corresponding pseudo-random sequence generated for each symbol.

In a non-limiting example, two symbols may be indicated to include SRS transmissions in a slot, and SRS hopping randomization is to be performed for cyclic shifts. The maximum number of cyclic shifts

$$( e . g . , {n}_{SRS}^{cs , max} )$$

may be 8 such that the number of consecutive entries (e.g., bits) allocated to indicate a particular cyclic shift may be 3 (e.g., M=3). The UE may generate a first pseudo-random sequence (e.g., cₗ(n)) based at least in part on a time-varying initialization seed (e.g., an initialization seed for a first symbol index, l=7). The first entries of the generated first pseudo-random sequence may be {011100110101}. A first fixed portion of the generated first pseudo-random sequence including three consecutive entries {011} may be used to determine the cyclic shift for the first symbol (e.g., l=7) in the slot. The UE may also generate a second pseudo-random sequence (e.g., c₂(n)) based at least in part on a time-varying initialization seed (e.g., an initialization seed for a second symbol index, l=8). The first entries of the generated second pseudo-random sequence may be {110000101100}. In a similar manner as in determining the cyclic shift for the first symbol, a first fixed portion of the generated second pseudo-random sequence including three consecutive entries {110} may be used to determine the cyclic shift for the second symbol (e.g., l=8) in the slot.

That is, for example, the cyclic shift may be hopping in a randomized manner with respect to the corresponding SRS transmissions in each of the two symbols in the slot (e.g., intra-slot SRS cyclic shift hopping). It is to be appreciated that the above non-limiting example may be similarly applied to other cyclic shifts (e.g., 12 or 6) as well as transmission comb sizes (e.g., 2, 4 or 8) as in accordance with the various embodiments described herein.

In some embodiments of the method 200, for example, the UE may be configured to receive a first transmission comb offset value. In some embodiments the first SRS transmission may be transmitted in accordance with the first transmission comb offset that is determined based at least in part on the generated first pseudo-random sequence and the first transmission comb offset value.

That is, for SRS transmission comb offset hopping randomization, the network or the network device may configure the SRS hopping indicator to include an identifier (e.g.,

$$( e . g . , {n}_{ID}^{SRS , Hopping} )$$

to initialize the first pseudo-random sequence. The first pseudo-random sequence may be using a different and time-varying initialization seed (e.g., ck), based at least in part on any one, or both of the size of the SRS hopping indicator or the symbol index for the first symbol. That is, for example, a pseudo-random sequence may be initialized for each symbol that is to include an SRS transmission. However, in some embodiments, a same pseudo-random sequence may be used for each symbol in a slot that is to include an SRS transmission as described herein.

In some embodiments, a number of M bits and corresponding values (or a single bit and corresponding value, when K_{TC}=2) may be determined and denoted O_{symb} for symbol symb, with a symbol index

$$( e . g . , l = 0 , 1 , 2 , 3 , … , {N}_{symb}^{slot} - 1 ) .$$

For a particular SRS port, the network or network device may configure the UE to use the first transmission comb offset value

$$( e . g . , {k}_{O}^{i} ) .$$

That is, for example, the first transmission comb offset value may be received in a higher layer parameter (e.g., combOffset) in an information element (e.g., SRS-Resource). In some embodiments, the information element (e.g., SRS-Resource) may be received in the SRS configuration.

In some embodiments, the first transmission comb offset value may serve as a starting or initial value for a randomized transmission comb offset value when SRS hopping randomization is applied. That is, for example, the randomized transmission comb offset value may be determined to be

$$( {k}_{O}^{i} + {O}_{symb} ) mod {K}_{TC} . ,$$

where K_{TC} is the transmission comb size.

However, in some embodiments, the first transmission comb offset value may also serve as a static transmission comb offset value when hopping randomization is not applied.

In some embodiments of the method 200, for example, the UE may be configured to receive a first cyclic shift value. In some embodiments, the first SRS transmission may be transmitted in accordance with the first cyclic shift that is determined based at least in part on the generated first pseudo-random sequence and the first cyclic shift value.

That is, for SRS cyclic shift hopping randomization, the network or the network device may configure the SRS hopping indicator to include an identifier

$$( e . g . , {n}_{ID}^{SRS , Hopping} )$$

to initialize the first pseudo-random sequence. The first pseudo-random sequence may be using a different and time-varying initialization seed (e.g., cᵢₙᵢₜ), based at least in part on any one, or both, of the size of the SRS hopping indicator or the symbol index for the first symbol. That is, for example, a pseudo-random sequence may be initialized for each symbol that is to include an SRS transmission. However, in some embodiments, a same pseudo-random sequence may be used for each symbol in a slot that is to include an SRS transmission as described herein.

In some embodiments, a number of M bits and corresponding values may be determined and denoted O_{symb} for symbol symb, with a symbol index

$$( e . g . , l = 0 , 1 , 2 , 3 , … , {N}_{symb}^{slot} - 1 ) .$$

For a particular SRS port, the network or network device may configure the UE to use the first cyclic shift value

$$( e . g . , {n}_{SRS}^{cs , i} ) .$$

That is, for example, the first cyclic shift value may be received in a higher layer parameter (e.g., cyclicShift) in an information element (e.g., SRS-Resource). In some embodiments, the information element (e.g., SRS-Resource) may be received in the SRS configuration.

In some embodiments, the first cyclic shift value may serve as a starting or initial value for a randomized cyclic shift value when SRS hopping randomization is applied. That is, for example, the randomized cyclic shift value may be determined to be

$$( {n}_{SRS}^{cs , i} + {O}_{symb} ) mod {n}_{SRS}^{cs , max} , where {n}_{SRS}^{cs , max}$$

is the maximum number of cyclic shifts (e.g., determined from the transmission comb size).

However, in some embodiments, the first cyclic shift value may also serve as a static cyclic shift value when hopping randomization is not applied.

In some embodiments of the method 200, for example, the first SRS transmission may be transmitted in accordance with the first transmission comb offset and the first cyclic shift that are determined based at least in part on the generated first pseudo-random sequence. In some embodiments, a first portion of the generated first pseudo-random sequence may be used to determine the first transmission comb offset. In some embodiments, a second portion of the generated first pseudo-random sequence may be used to determine the first cyclic shift. In some embodiments, the first portion of the generated first pseudo-random sequence may be different from the second portion of the generated first pseudo-random sequence.

That is, for example, a number of M bits and corresponding values may be determined for both transmission comb offset hopping randomization and cyclic shift hopping randomization. In some embodiments, the M bits may be divided into two parts (e.g., the first portion and the second portion). That is, for example, the first portion of the M bits may be used to determine the transmission comb offset hopping randomization and the second portion of the M bits may be used to determine the cyclic shift hopping randomization.

The first portion of the M bits may be denoted

$${O}_{symb}^{comb}$$

for symbol symb, with a symbol index

$$( e . g . , l = 0 , 1 , 2 , 3 , … , {N}_{symb}^{slot} - 1 ) .$$

The second portion of the Mbits may be denoted

$${O}_{symb}^{CS}$$

for symbol symb, with a symbol index

$$( e . g . , l = 0 , 1 , 2 , 3 , … , {N}_{s y m b}^{slot} - 1 ) .$$

In some embodiments, the network or network device may configure the UE to use the first transmission comb offset value

$$( e . g . , {k}_{O}^{i} )$$

and the first cyclic shift value

$$( e . g . , {n}_{S R S}^{c s i} ) .$$

That is, for example, the first transmission comb offset value may be received in a higher layer parameter (e.g., combOffset) in an information element (e.g., SRS-Resource) and the first cyclic shift value may be received in a higher layer parameter (e.g., cyclicShift) in the same information element (e.g., SRS-Resource). In some embodiments, the first transmission comb offset value may serve as a starting or initial value for a randomized transmission comb offset value and the first cyclic shift value may serve as a starting or initial value for a randomized cyclic shift value when hopping randomization is applied. That is, for example, the randomized transmission comb offset value may be determined to be

$$( {k}_{O}^{i} + {O}_{s y m b}^{c o m b} ) mod {K}_{T C} ,$$

and the randomized cyclic shift value may be determined to be

$$( {n}_{S R S}^{cs , i} + {O}_{s y m b}^{CS} ) mod {n}_{S R S}^{cs , max} .$$

In some embodiments of the method 200, for example, the UE may be configured to perform at least one of a floor operation or a modulo operation to determine the first portion and the second portion of the generated first pseudo-random sequence.

That is, for example, the M bits may be divided into two parts (e.g., the first portion and the second portion) in accordance with some embodiments. In some embodiments, the M bits may be divided into M₁ bits and M₂ bits, where M=M₁+M₂. The first portion (e.g., M₁ bits) of the M bits may be used to determine the transmission comb offset hopping randomization and the second portion (e.g., M₂) of the M bits may be used to determine the cyclic shift hopping randomization. By way of example, for a transmission comb size (e.g., K_{TC}) equal to 4, the maximum number of cyclic shifts

$$( e . g . , {n}_{S R S}^{cs , max} )$$

equal to 12, M equals 6, where M₁ is 2 and M₂ is 4.

In some embodiments, a floor operation and modulo operation may be used to separate the M bits into two parts (e.g., the first portion and the second portion). That is, in a non-limiting example, M bits may be separated according to the following equation:

$${O}_{symb}^{comb} = {O}_{s y m b} mod {n}_{S R S}^{cs , max} ; {O}_{symb}^{CS} = ⌊ \frac{{O}_{symb}}{{n}_{S R S}^{cs , max}} ⌋ \qquad ( eq . 3 )$$

In another non-limiting example, M bits may be separated according to the following equation:

$${O}_{s y m b}^{c o m b} = ⌊ \frac{{O}_{s y m b}}{{K}_{T C}} ⌋ ; {O}_{s y m b}^{C S} = {O}_{s y m b} mod {K}_{T C} \qquad ( eq . 4 )$$

It is to be appreciated that M bits may be separated by various techniques given the benefit of Equations 3 and 4 along with the various embodiments described herein.

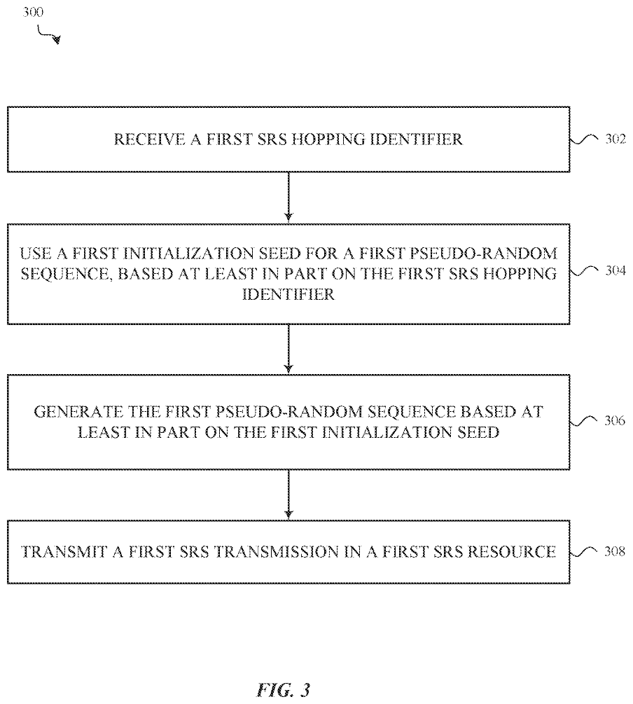

FIG. 3 illustrates a second example method 300 of wireless communication by a UE, in accordance with some embodiments and various aspects of the present disclosure. The method 300 may be performed by the first UE 102a or the second UE 102b described with reference to FIG. 1 or by other UEs described herein. The method 300 may be performed using a processor, a set of transceivers (e.g., one or more transceivers) or other components of a UE.

At 302, the method 300 may include receiving a first SRS hopping identifier.

At 304, the method 300 may include determining and/or using a first initialization seed for a first pseudo-random sequence, based at least in part on the first SRS hopping identifier.

At 306, the method 300 may include generating the first pseudo-random sequence based at least in part on the determined/used first initialization seed.

At 308, the method 300 may include transmitting a first SRS transmission in a first SRS resource.

In some embodiments of the method 300, the first SRS transmission may be transmitted in accordance with at least one of a first transmission comb offset, or a first cyclic shift, that is determined based at least in part on the generated first pseudo-random sequence. In some embodiments, the first SRS hopping identifier may correspond to a first UL bandwidth part (BWP) in a first cell.

In some embodiments, the first SRS hopping identifier may also correspond to a second UL BWP in the first cell. That is, for example, the first SRS hopping identifier may correspond to all UL BWPs in the particular cell.

In some embodiments of the method 300, for example, the UE may be configured to receive a second SRS hopping identifier. In some embodiments, the UE may be configured to use a second initialization seed for a second pseudo-random sequence, based at least in part on the second SRS hopping identifier. In some embodiments, the UE may be configured to generate the second pseudo-random sequence based at least in part on the second initialization seed. In some embodiments, the UE may be configured to transmit a second SRS transmission in a second SRS resource. In some embodiments, the second SRS transmission may be transmitted in accordance with at least one of a second transmission comb offset, or a second cyclic shift, that is determined based at least in part on the generated second pseudo-random sequence. In some embodiments, the second SRS hopping identifier may correspond to a second UL BWP in the first cell. In some embodiments, the first SRS hopping identifier may be different from the second SRS hopping identifier.

In some embodiments of the method 300, for example, the first SRS hopping identifier may be received via RRC signaling as part of a UL configuration.

That is, for example, the first SRS hopping identifier may be a higher layer parameter

$$( e . g . , {n}_{I D 1}^{SRS , Hopping} ) ,$$

which may be contained in an information element for an UL configuration (e.g., UplinkConfig). Additionally, the second SRS hopping identifier may be a higher layer parameter

$$( e . g . , {n}_{ID 2}^{SRS , Hopping} ) ,$$

which may also be contained in the information element for the UL configuration (e.g., UplinkConfig).

In some embodiments of the method 300, for example the first SRS hopping identifier may be configured for one of a first SRS resource of the first UL BWP in the first cell; a first SRS resource set of the first UL BWP in the first cell; or a first SRS configuration of the first UL BWP in the first cell.

That is, for example, the first SRS hopping identifier may be configured per SRS-Resource, per SRS-ResourceSet, or per SRS-Config. When an SRS hopping identifier is configured per SRS-ResourceSet, all of the SRS-Resources in the same SRS-ResourceSet may use the same SRS hopping identifier. When an SRS hopping identifier is configured per SRS-Config, all of the SRS-Resources in the same SRS-Config may use the same SRS hopping identifier.

In some embodiments of the method 300, for example, the UE may be configured to receive a second SRS hopping identifier. In some embodiments, the first SRS hopping identifier may be configured for a first SRS resource set of the first UL BWP in the first cell. In some embodiments, the second SRS hopping identifier may be configured for a second SRS resource set of the first UL BWP in the first cell. In some embodiments, the first SRS resource may be configured in the first SRS resource set and second SRS resource set. In some embodiments, the first initialization seed may be used to generate the first pseudo-random sequence, based at least in part on the first SRS resource set having a lower SRS resource set identifier value than the second SRS resource set.

That is, for transmission comb offset hopping randomization or cyclic shift hopping randomization, the network or the network device may configure the SRS hopping indicator to include a first SRS hopping identifier

$$( e . g . , {n}_{I D 1}^{SRS , Hopping} )$$

to initialize the first pseudo-random sequence. In some embodiments, if an SRS-Resource belongs to more than one SRS-ResourceSet (e.g., a first SRS-ResourceSet and a second SRS-ResourceSet), the SRS-Resource may be transmitted with the SRS identifier of the SRS-ResourceSet with the lowest SRS-ResourceSetId among all the SRS-ResourceSets that contain the corresponding SRS-Resource.

However, in some embodiments, depending on which SRS-ResourceSet is configured to be transmitted, the same SRS-Resource may be transmitted with different SRS identifiers. That is, for example, the SRS-Resource may be transmitted according to the first SRS hopping identifier when other SRS transmissions are to be transmitted in the first SRS-ResourceSet with the first SRS transmission in a first symbol. However, the SRS-Resource may be transmitted according to the second SRS hopping identifier

$$( e . g . , {n}_{ID 2}^{SRS , Hopping} )$$

that may initialize a second pseudo-random sequence when other SRS transmissions are to be transmitted in the second SRS-ResourceSet.

In some embodiments of the method 300, for example, the UE may be configured to determine that a second SRS transmission is to be transmitted in a second SRS resource. In some embodiments, the UE may be configured to determine that the second SRS resource is not configured with the first SRS hopping identifier. In some embodiments, the UE may be configured to identify a default SRS hopping identifier for the second SRS resource. In some embodiments, the UE may be configured to determine and/or use a second initialization seed for a second pseudo-random sequence, based at least in part on the default SRS hopping identifier. In some embodiments, the UE may be configured to generate the second pseudo-random sequence based at least in part on the first initialization seed. In some embodiments, the UE may be configured to transmit the second SRS transmission in the second SRS resource.

In some embodiments, the default SRS hopping identifier may be based at least in part on at least one of a physical layer cell identifier; a radio network temporary identifier (RNTI); or an SRS resource identifier value.

That is, for example, if an SRS-Resource is not in any SRS-ResourceSet, and thus not assigned to any SRS hopping identifier, a default SRS hopping identifier

$$( e . g . , {n}_{DefaultID}^{S R S , H o p p i n g} )$$

may be used for the SRS-Resource. That is, for example, if the network or network device does not explicitly configure an SRS hopping identifier, the default SRS hopping identifier may be used for the initialization of the pseudo-random sequence for the SRS-Resource.

In some embodiments, the default SRS hopping identifier may be a physical layer cell identifier

$$( e . g . , {N}_{I D}^{cell} ) ,$$

an RNTI (e.g., n_{RNTI} given by the C-RNTI) configured by the network or network device for the UE, an SRS-ResourceID by the network or network device, or any combination thereof. In some embodiments, the default SRS hopping identifier may be a combination of the C-RNTI, the maxNrofSRS-Resources and the SRS-ResourceId of the SRS-Resource that is not assigned to any SRS hopping identifier. In some embodiments, the default SRS hopping identifier may be a combination of the physical cell ID, maxNrofSRS-Resources and SRS-ResourceId of the SRS-Resource that is not assigned to any SRS hopping identifier.

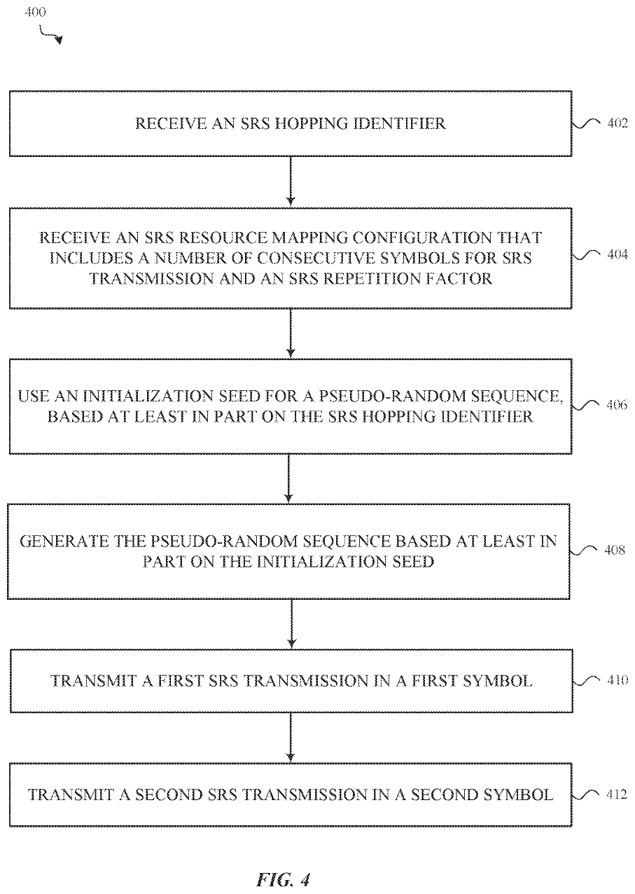

FIG. 4 illustrates a third example method 400 of wireless communication by a UE, in accordance with some embodiments and various aspects of the present disclosure. The method 400 may be performed by the first UE 102a or the second UE 102b described with reference to FIG. 1 or by other UEs described herein. The method 400 may be performed using a processor, a set of transceivers (e.g., one or more transceivers) or other components of a UE.

At 402, the method 400 may include receiving an SRS hopping identifier.

At 404, the method 400 may include receiving an SRS resource mapping configuration that includes a number of consecutive symbols for SRS transmission and an SRS repetition factor.

At 406, the method 400 may include determining and/or using an initialization seed for a pseudo-random sequence, based at least in part on the SRS hopping identifier.

At 408, the method 400 may include generating the pseudo-random sequence based at least in part on the initialization seed.

At 410, the method 400 may include transmitting a first SRS transmission in a first symbol.

At 412, the method 400 may include transmitting a second SRS transmission in a second symbol.

In some embodiments of the method 400, for example, the first SRS transmission may be transmitted in accordance with at least one of a first transmission comb offset, or a first cyclic shift, that is determined based at least in part on the generated pseudo-random sequence. In some embodiments, the second SRS transmission may be transmitted in accordance with a same transmission comb offset, or a same cyclic shift as the first SRS transmission, based at least in part on the SRS repetition factor. In some embodiments, the number of consecutive symbols for SRS transmission may be greater than the SRS repetition factor.

In some embodiments of the method 400, for example, the number of consecutive symbols for SRS transmission may be divided into equal segments, based at least in part on the SRS repetition factor.

In some embodiments of the method 400, for example, the UE may be configured to transmit a third SRS transmission in a third symbol. In some embodiments, the UE may be configured to transmit a fourth SRS transmission in a fourth symbol. In some embodiments, the third SRS transmission may be transmitted in accordance with at least one of a second transmission comb offset, or a second cyclic shift, that is determined based at least in part on the generated pseudo-random sequence. In some embodiments, the fourth SRS transmission may be transmitted in accordance with a same transmission comb offset, or a same cyclic shift as the third SRS transmission, based at least in part on the SRS repetition factor.

That is, for SRS transmission comb offset hopping randomization and/or cyclic shift hopping randomization, the network or the network device may configure an SRS hopping identifier

$$( e . g . , {n}_{ID}^{S R S , H o p p i n g} )$$

to initialize the pseudo-random sequence. The network or the network device may also disable SRS transmission comb offset hopping randomization and/or cyclic shift hopping randomization for intra-slot hopping randomization. That is, for example, the network or the network device may configure an SRS resource mapping configuration that includes an SRS repetition factor for intra-slot hopping. The SRS resource mapping configuration may also include a number of consecutive symbols for SRS transmission. In some embodiments, the SRS resource mapping configuration may be sent to the UE via RRC signaling, for example, in an information element (e.g., resourceMapping). The SRS repetition factor may be a field or parameter (e.g., repetitionFactor) in the information element (e.g., resourceMapping). Similarly, the number of consecutive symbols for SRS transmission may be a field or parameter (e.g., nrofSymbols) in the information element (e.g., resourceMapping).

In a non-limiting example, when the network or network device configures an eight symbol SRS-Resource (e.g., nrofSymbols=n8) and a four symbol repetition factor (e.g., repetitionFactor=4), the UE may divide the eight symbol SRS-Resource into two segments. That is, for example, a first segment may include the first four consecutive symbols and a second segment may include the second four consecutive symbols.

In some embodiments, when the network or network device disables the intra-slot SRS transmission comb offset hopping randomization and/or cyclic shift hopping randomization, the UE may not perform the SRS transmission comb offset hopping randomization and/or the cyclic shift hopping randomization within each segment (e.g., neither within the first segment that includes the first four consecutive symbols, nor within the second segment that includes the second four consecutive symbols). In other words, the UE does not perform SRS transmission comb offset hopping randomization and/or cyclic shift hopping randomization within a given segment. In some embodiments, however, across different segments, the UE may perform SRS transmission comb offset hopping randomization and/or cyclic shift hopping randomization.

Embodiments contemplated herein include a complementary context of method 200, 300, or 400. For example, the complementary context of method 200 may include transmitting an SRS configuration that includes an SRS hopping indicator; and receiving a first SRS transmission in a first symbol. The first SRS transmission may be received in accordance with at least one of a first transmission comb offset or a first cyclic shift that was determined, based at least in part on a generated first pseudo-random sequence.

The complementary context of method 300 may include transmitting a first SRS hopping identifier; and receiving a first SRS transmission in a first SRS resource. The transmitted first SRS hopping identifier may correspond to a first UL BWP in a first cell. The first SRS transmission may be received in accordance with at least one of a first transmission comb offset or a first cyclic shift that was determined, based at least in part on a generated first pseudo-random sequence.

The complementary context of method 400 may include transmitting an SRS hopping identifier; transmitting an SRS resource mapping configuration that includes a number of consecutive symbols for SRS transmission and an SRS repetition factor; receiving a first SRS transmission in a first symbol; and receiving a second SRS transmission in a second symbol. The first SRS transmission may be received in accordance with at least one of a first transmission comb offset or a first cyclic shift that was determined, based at least in part on a generated pseudo-random sequence. The second SRS transmission may be received in accordance with a same transmission comb offset, or a same cyclic shift as the first SRS transmission, based at least in part on the transmitted SRS repetition factor. The transmitted number of consecutive symbols for SRS transmission may be greater than the transmitted SRS repetition factor.

Embodiments contemplated herein include an apparatus having means to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a network device (such as a network device 620 that can be a network device of a RAN, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200, 300, or 400, the non-transitory computer-readable media may be, for example, a memory of a UE (such as a memory 606 of a wireless device 602 that is a UE, as described herein). As would be apparent given the benefit of the disclosure and embodiments described herein, in the complementary context of method 200, 300, or 400, the non-transitory computer-readable media may be, for example, a memory of a network device (such as a memory 624 of a network device 620 that can be a network device of a RAN, as described herein).

Embodiments contemplated herein include an apparatus having logic, modules, or circuitry to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a network device (such as a network device 620 that can be a network device of a RAN, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200, 300, or 400, the apparatus may be, for example, an apparatus of a UE (such as a wireless device 602 that is a UE, as described herein). As would be apparent given the benefit of the disclosure and embodiments described herein, in the complementary context of method 200, 300, or 400, the apparatus may be, for example, an apparatus of a network device (such as a network device 620 that can be a network device of a RAN, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the methods 200, 300, or 400. In the context of method 200, 300, or 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). As would be apparent given the benefit of the disclosure and embodiments described herein, in the complementary context of method 200, 300, or 400, the processor may be a processor of a network device (such as a processor(s) 622 of a network device 620 that can be a network device of a RAN, as described herein), and the instructions may be, for example, located in the processor and/or on a memory of the network device (such as a memory 624 of a network device 620 that can be a network device of a RAN, as described herein).

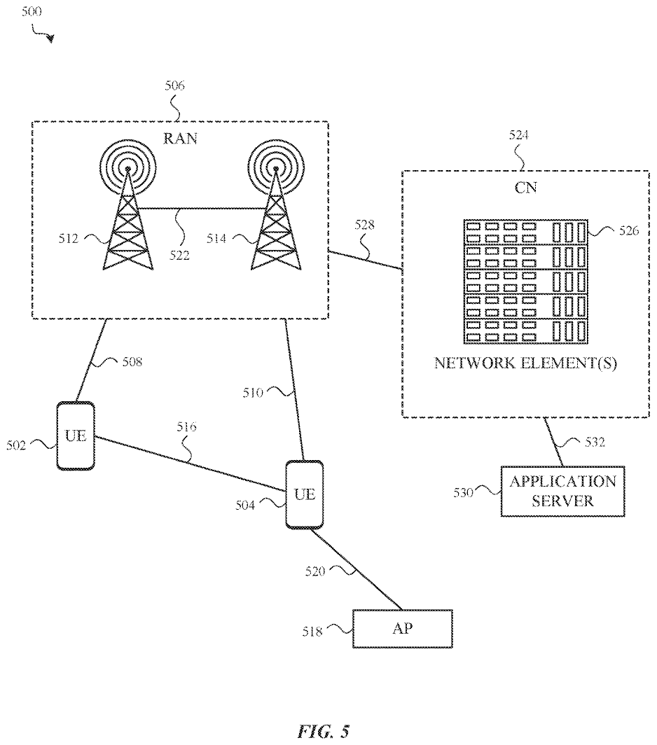

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also include any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which includes a physical communications interface. The RAN 506 can include one or more network devices, such as network device 512 and network device 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can include a local wireless connection, such as a connection consistent with any IEEE 802.11 protocol, wherein the AP 518 may include a Wi-Fi® router. In this example, the AP 518 may be connected to another network (for example, the Internet) without going through a CN 524.

In embodiments, the UE 502 and UE 504 can be configured to communicate using OFDM communication signals with each other or with the network device 512 and/or the network device 514 over a multicarrier communication channel in accordance with various communication techniques, such as, but not limited to, an orthogonal frequency division multiple access (OFDMA) communication technique (e.g., for DL communications) or a single carrier frequency division multiple access (SC-FDMA) communication technique (e.g., for UL and ProSe or sidelink communications), although the scope of the embodiments is not limited in this respect. The OFDM signals can include a plurality of orthogonal subcarriers.

In some embodiments, all or parts of the network device 512 or network device 514 may be implemented as one or more software entities running on server computers as part of a virtual network. In addition, or in other embodiments, the network device 512 or network device 514 may be configured to communicate with one another via interface 522. In embodiments where the wireless communication system 500 is an LTE system (e.g., when the CN 524 is an EPC), the interface 522 may be an X2 interface. The X2 interface may be defined between two or more network devices (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more network devices (e.g., two or more gNBs and the like) that connect to 5GC, between a network device 512 (e.g., a gNB) connecting to 5GC and an eNB, and/or between two eNBs connecting to 5GC (e.g., CN 524).

The RAN 506 is shown to be communicatively coupled to the CN 524. The CN 524 may include one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an interface 528 (e.g., an S1 interface). In embodiments, the S1 interface may be split into two parts, an S1 user plane (S1-U) interface, which carries traffic data between the network device 512 or network device 514 and a serving gateway (S-GW), and the S1-MME interface, which is a signaling interface between the network device 512 or network device 514 and mobility management entities (MMEs).

In embodiments, the CN 524 may be a 5GC, and the RAN 506 may be connected with the CN 524 via an interface 528 (e.g., an NG interface). In embodiments, the NG interface may be split into two parts, an NG user plane (NG-U) interface, which carries traffic data between the network device 512 or network device 514 and a user plane function (UPF), and the S1 control plane (NG-C) interface, which is a signaling interface between the network device 512 or network device 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

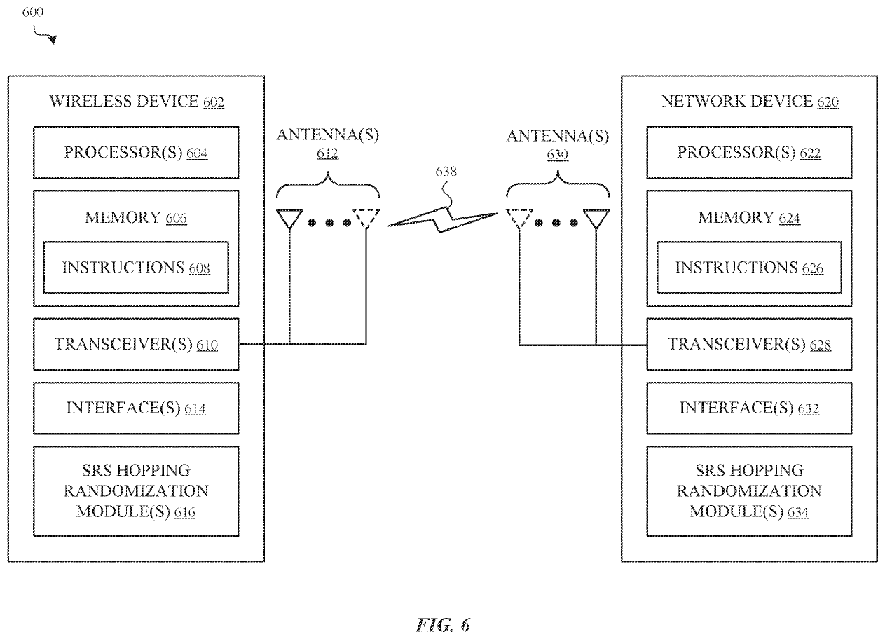

FIG. 6 illustrates a system 600 for performing signaling 638 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a network device (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include an SRS hopping randomization module(s) 616. The SRS hopping randomization module(s) 616 may be implemented via hardware, software, or combinations thereof. For example, the SRS hopping randomization module(s) 616 may be implemented as a processor, circuit, and/or instructions 608 stored in the memory 606 and executed by the processor(s) 604. In some examples, the SRS hopping randomization module(s) 616 may be integrated within the processor(s) 604 and/or the transceiver(s) 610. For example, the SRS hopping randomization module(s) 616 may be implemented by a combination of software components (e.g., executed by a DSP or a general processor) and hardware components (e.g., logic gates and circuitry) within the processor(s) 604 or the transceiver(s) 610.

The SRS hopping randomization module(s) 616 may be used for various aspects of the present disclosure, for example, aspects of FIG. 1 through FIG. 4. The SRS hopping randomization module(s) 616 may be configured to, for example, apply or implement SRS enhancement and hopping randomization techniques described herein.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a network device may include interface(s) 632 made up of transmitters, receivers, and other circuitry (e.g., other than the transceiver(s) 628 and antenna(s) 630 already described) that enables the network device to communicate with other equipment in a core network, and/or that enables the network device to communicate with external networks, computers, databases, and the like for purposes of operations, administration, and maintenance of the network device or other equipment operably connected thereto.

The network device 620 may include an SRS hopping randomization module(s) 634. The SRS hopping randomization module(s) 634 may be implemented via hardware, software, or combinations thereof. For example, the SRS hopping randomization module(s) 634 may be implemented as a processor, circuit, and/or instructions 626 stored in the memory 624 and executed by the processor(s) 622. In some examples, the SRS hopping randomization module(s) 634 may be integrated within the processor(s) 622 and/or the transceiver(s) 628. For example, the SRS hopping randomization module(s) 634 may be implemented by a combination of software components (e.g., executed by a DSP or a general processor) and hardware components (e.g., logic gates and circuitry) within the processor(s) 622 or the transceiver(s) 628.

The SRS hopping randomization module(s) 634 may be used for various aspects of the present disclosure, for example, aspects of FIG. 1 through FIG. 4. The SRS hopping randomization module(s) 634 may be configured to, for example, apply or implement SRS enhancement and hopping randomization techniques described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive a sounding reference signal (SRS) configuration that includes an SRS hopping indicator;
generate a first pseudo-random sequence, based at least in part on the SRS hopping indicator; and
generate, for transmission, a first SRS transmission in a first symbol; wherein:
the first SRS transmission is transmitted in accordance with at least one of a first transmission comb offset, or a first cyclic shift, that is determined based at least in part on the generated first pseudo-random sequence.

2. The apparatus of claim 1, wherein the first pseudo-random sequence comprises a length-31 Gold sequence.

3. The apparatus of claim 1, wherein the processor is configured to:
generate, for transmission, a second SRS transmission in a second symbol; wherein:
the first SRS transmission is transmitted in accordance with at least one of the first transmission comb offset, or the first cyclic shift, that is determined based at least in part on a first portion of the generated first pseudo-random sequence;
the second SRS transmission is transmitted in accordance with at least one of a second transmission comb offset, or a second cyclic shift, that is determined based at least in part on a second portion of the generated first pseudo-random sequence; and
the first portion of the generated first pseudo-random sequence is different from the second portion of the generated first pseudo-random sequence.

4. The apparatus of claim 1, wherein the processor is configured to:
generate a second pseudo-random sequence based at least in part on the SRS hopping indicator; and
generate, for transmission, a second SRS transmission in a second symbol; wherein:
the second SRS transmission is transmitted in accordance with at least one of a second transmission comb offset, or a second cyclic shift, that is determined based at least in part on the generated second pseudo-random sequence.

5. The apparatus of claim 1, wherein the SRS hopping indicator comprises an initialization seed for the first pseudo-random sequence.

6. The apparatus of claim 1, wherein:
at least one of the first transmission comb offset, or the first cyclic shift, is determined based at least in part on a first number of consecutive entries in the generated first pseudo-random sequence; and
the first number of consecutive entries corresponds to one or both of a transmission comb size or a maximum number of cyclic shifts associated with the first SRS transmission.

7. The apparatus of claim 1, wherein the processor is configured to:
use an initialization seed for the first pseudo-random sequence, based at least in part on at least one of a size of the SRS hopping indicator or a symbol index for the first symbol.

8. The apparatus of claim 1, wherein the processor is configured to:
receive a first transmission comb offset value; wherein:
the first SRS transmission is transmitted in accordance with the first transmission comb offset that is determined based at least in part on the generated first pseudo-random sequence and the first transmission comb offset value.

9. The apparatus of claim 1, wherein the processor is configured to:
receive a first cyclic shift value; wherein:
the first SRS transmission is transmitted in accordance with the first cyclic shift that is determined based at least in part on the generated first pseudo-random sequence and the first cyclic shift value.

10. The apparatus of claim 1, wherein:
the first SRS transmission is transmitted in accordance with the first transmission comb offset and the first cyclic shift that are determined based at least in part on the generated first pseudo-random sequence;
a first portion of the generated first pseudo-random sequence is used to determine the first transmission comb offset;
a second portion of the generated first pseudo-random sequence is used to determine the first cyclic shift; and
the first portion of the generated first pseudo-random sequence is different from the second portion of the generated first pseudo-random sequence.

11. The apparatus of claim 10, wherein the processor is configured to:
perform at least one of a floor operation or a modulo operation to determine the first portion and the second portion of the generated first pseudo-random sequence.

12. An apparatus comprising memory coupled to a processor, the processor configured to:
receive a first sounding reference signal (SRS) hopping identifier;
use a first initialization seed for a first pseudo-random sequence, based at least in part on the first SRS hopping identifier;
generate the first pseudo-random sequence, based at least in part on the first initialization seed; and
generate, for transmission, a first SRS transmission in a first SRS resource; wherein:
the first SRS transmission is transmitted in accordance with at least one of a first transmission comb offset, or a first cyclic shift, that is determined based at least in part on the generated first pseudo-random sequence; and
the first SRS hopping identifier corresponds to a first uplink (UL) bandwidth part (BWP) in a first cell.

13. The apparatus of claim 12, wherein the processor is configured to:
receive a second SRS hopping identifier;
use a second initialization seed for a second pseudo-random sequence, based at least in part on the second SRS hopping identifier;
generate the second pseudo-random sequence based at least in part on the second initialization seed; and
generate, for transmission, a second SRS transmission in a second SRS resource; wherein:
the second SRS transmission is transmitted in accordance with at least one of a second transmission comb offset, or a second cyclic shift, that is determined based at least in part on the generated second pseudo-random sequence;
the second SRS hopping identifier corresponds to a second UL BWP in the first cell; and
the first SRS hopping identifier is different from the second SRS hopping identifier.

14. The apparatus of claim 12, wherein the first SRS hopping identifier is received via radio resource control (RRC) signaling as part of a UL configuration.

15. The apparatus of claim 12, wherein the first SRS hopping identifier is configured for one of:
a first SRS resource of the first UL BWP in the first cell;
a first SRS resource set of the first UL BWP in the first cell; or
a first SRS configuration of the first UL BWP in the first cell.

16. The apparatus of claim 12, wherein the processor is configured to:
receive a second SRS hopping identifier; wherein:
the first SRS hopping identifier is configured for a first SRS resource set of the first UL BWP in the first cell;
the second SRS hopping identifier is configured for a second SRS resource set of the first UL BWP in the first cell;
the first SRS resource is configured in the first SRS resource set and second SRS resource set; and
the first initialization seed is used to generate the first pseudo-random sequence, based at least in part on the first SRS resource set having a lower SRS resource set identifier value than the second SRS resource set.

17. The apparatus of claim 12, wherein the processor is configured to:
determine that a second SRS transmission is to be transmitted in a second SRS resource;
determine that the second SRS resource is not configured with the first SRS hopping identifier;
identify a default SRS hopping identifier for the second SRS resource;
use a second initialization seed for a second pseudo-random sequence, based at least in part on the default SRS hopping identifier;
generate the second pseudo-random sequence based at least in part on the first initialization seed; and
generate, for transmission, the second SRS transmission in the second SRS resource; wherein:
the default SRS hopping identifier is based at least in part on at least one of,
a physical layer cell identifier;
a radio network temporary identifier (RNTI); or
an SRS resource identifier value.

18. An apparatus comprising memory coupled to a processor, the processor configured to:
receive a sounding reference signal (SRS) hopping identifier;
receive an SRS resource mapping configuration that includes a number of consecutive symbols for SRS transmission and an SRS repetition factor;
use an initialization seed for a pseudo-random sequence, based at least in part on the SRS hopping identifier;
generate the pseudo-random sequence, based at least in part on the initialization seed;
generate, for transmission, a first SRS transmission in a first symbol; and
generate, for transmission, a second SRS transmission in a second symbol; wherein:
the first SRS transmission is transmitted in accordance with at least one of a first transmission comb offset, or a first cyclic shift, that is determined based at least in part on the generated pseudo-random sequence;
the second SRS transmission is transmitted in accordance with a same transmission comb offset, or a same cyclic shift as the first SRS transmission, based at least in part on the SRS repetition factor; and
the number of consecutive symbols for SRS transmission is greater than the SRS repetition factor.

19. The apparatus of claim 18, wherein the number of consecutive symbols for SRS transmission is divided into equal segments, based at least in part on the SRS repetition factor.

20. The apparatus of claim 18, wherein the processor is configured to:
generate, for transmission, a third SRS transmission in a third symbol; and
generate, for transmission, a fourth SRS transmission in a fourth symbol; wherein:
the third SRS transmission is transmitted in accordance with at least one of a second transmission comb offset, or a second cyclic shift, that is determined based at least in part on the generated pseudo-random sequence; and
the fourth SRS transmission is transmitted in accordance with a same transmission comb offset, or a same cyclic shift as the third SRS transmission, based at least in part on the SRS repetition factor.
